(19) United States
(12) Patent Application Publication
(10) Pub. No.: US 2011/0007284 A1
(43) Pub. Date: Jan. 13, 2011

(54) METHOD AND APPARATUS FOR USE IN PROJECTING IMAGES

(75) Inventors: Blaise R.J. Robitaille, Barrie (CA); Michael D. Thorpe, Penetanguishene (CA)

Correspondence Address: HAYNES AND BOONE, LLP;IP Section, 2323 Victory Avenue, Suite 700, Dallas, TX, 75219, US

(73) Assignee: Raytheon Company, Waltham, MA (US)

(21) Appl. No.: 12/832,510

(22) Filed: Jul. 8, 2010

Related U.S. Application Data
(60) Provisional application No. 61/224,210, filed on Jul. 9, 2009.

(51) Int. Cl. G03B 21/20; G03B 21/28

(52) U.S. Cl. 353/81; 353/100; 353/99; 353/84; 353/121

(57) ABSTRACT

A method and apparatus relate to a projection module having an input port with light source module mounting structure, an output port with lens module mounting structure, an image forming section, and optics. The method and apparatus involve: routing radiation arriving through the input port along a first path of travel defined by the optics to the image forming section; generating images at the image forming section from the radiation arriving along the first path of travel; and routing images from the image forming section to and through the output port along a second path of travel defined by the optics.

This application claims the priority under 35 U.S.C. §119 of provisional application No. 61/224,210 filed Jul. 9, 2009, the entire disclosure of which is hereby incorporated herein by reference.

### FIELD OF THE INVENTION

This invention relates in general to optical systems and, more particularly, to techniques for projecting images.

### BACKGROUND

There are a variety of different applications in which digital images are converted into optical images and then projected onto a screen. As one specific example, flight simulators have various instrument panels that display varying information to a pilot. Each display is unique in size, depending on the information being displayed. As a result, different display areas and/or different technologies are often used to implement each application. Some displays present color information, while others present monochrome information. Consequently, the projection apparatus for each display application has traditionally been a custom design tailored to the specific requirements, but this approach tends to drive up the overall cost of a flight simulator system. Also, displays have often been implemented with cathode ray tube (CRT) technology, but these types of displays take up space, and are inefficient in their use of energy. Consequently, although existing arrangements of this type have been generally adequate for their intended purposes, they have not been entirely satisfactory in all respects.

### BRIEF DESCRIPTION OF THE DRAWINGS

A better understanding of the present invention will be realized from the detailed description that follows, taken in conjunction with the accompanying drawings, in which:

FIG. 1 is a diagrammatic perspective view of a projection apparatus that embodies aspects of the invention, and that includes a light source module, a projection engine module, and a projection lens module.

FIG. 2 is a diagrammatic fragmentary exploded perspective view of a portion of the apparatus of FIG. 1, showing how the projection lens module is detachably coupled to the projection engine module.

FIG. 3 is a diagrammatic fragmentary perspective view of a portion of the projection engine module of FIG. 1.

FIG. 4 is a diagrammatic fragmentary perspective view of an end portion of the light source module of FIG. 1.

FIG. 5 is a diagrammatic top view of optical components provided within the projection engine module and projection lens module of FIG. 1.

FIG. 6 is a diagrammatic side view of the optical components of FIG. 5.

FIG. 7 is a diagrammatic rear view of the optical components of FIG. 5.

FIG. 8 is a diagrammatic sectional view taken along section line 8-8 in FIG. 7.

FIG. 9 is a diagrammatic perspective view of a projection apparatus that is an alternative embodiment of the projection apparatus of FIG. 1.

FIG. 10 is a diagrammatic view showing optical components that are provided within a projection lens module of the projection apparatus of FIG. 9.

### DETAILED DESCRIPTION

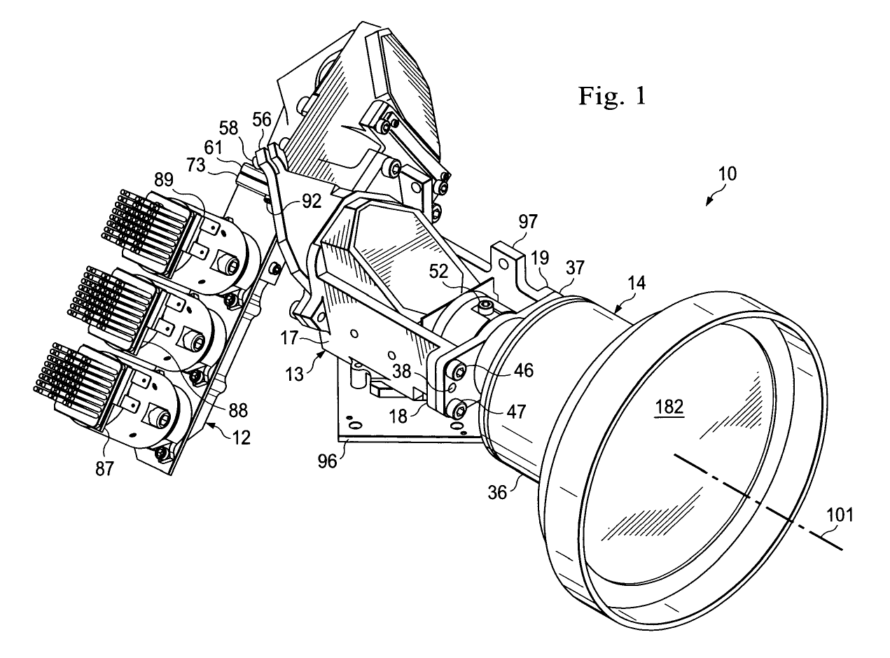

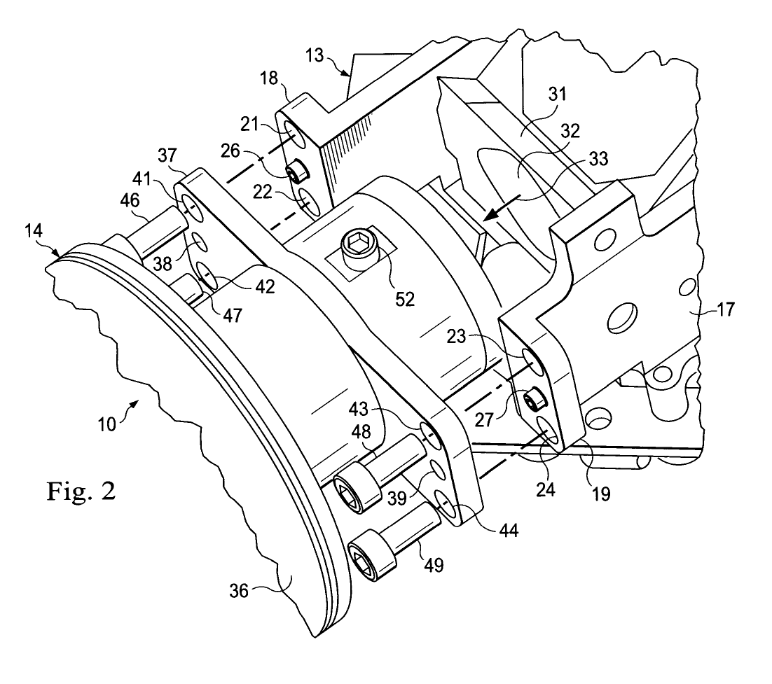

FIG. 1 is a diagrammatic perspective view of a projection apparatus 10 that embodies aspects of the invention, and that can project images onto a not-illustrated screen. The projection apparatus 10 includes a polychromatic light source module 12, a projection engine module 13, and a projection lens module 14. The projection engine module 13 and projection lens module 14 are sometimes referred to collectively as a projection engine. FIG. 2 is a diagrammatic fragmentary exploded perspective view of a portion of the apparatus 10 of FIG. 1, showing how the projection lens module 14 is detachably coupled to the projection engine module 13.

The projection engine module 13 includes a housing 17 having two spaced flanges 18 and 19 at one end. The flange 18 has two spaced threaded holes 21 and 22, and the flange 19 has two spaced threaded holes 23 and 24. A cylindrical alignment pin 26 projects outwardly from the flange 18 at a location between the threaded holes 21 and 22, and a cylindrical alignment pin 27 projects outwardly from the flange 19 at a location between the threaded holes 23 and 24. The projection engine module 13 has a prism 31 supported between the flanges 18 and 19. The prism 31, which will be described in more detail later, has a surface 32. As indicated diagrammatically by an arrow 33, a series of optical images exit the projection engine module 13 through the surface 32 of prism 31. This represents an optical outlet port of the projection engine module 13.

The projection lens module 14 has a housing 36 that includes a plate-like flange 37. The flange 37 has two spaced cylindrical alignment holes 38 and 39 that each snugly and slidably receive a respective one of the alignment pins 26 and 27. In addition, the flange 37 has two cylindrical holes 41 and 42 that extend therethrough on opposite sides of the alignment hole 38, and two further cylindrical holes 43 and 44 that extend therethrough on opposite sides on the alignment hole 39. Four screws 46-49 each extend through a respective one of the holes 41-44 in the flange 37, and each engage a respective one of the threaded holes 21-24 in the flanges 18 and 19, in order to fixedly secure the projection lens module 14 to the projection engine module 13 with an accurate alignment, so that images exiting the projection engine module 13 at 33 enter the projection lens module 14. A setscrew 52 engages a threaded opening that extends through a wall of the housing 36 of the projection lens module 14, for a purpose that will be discussed later.

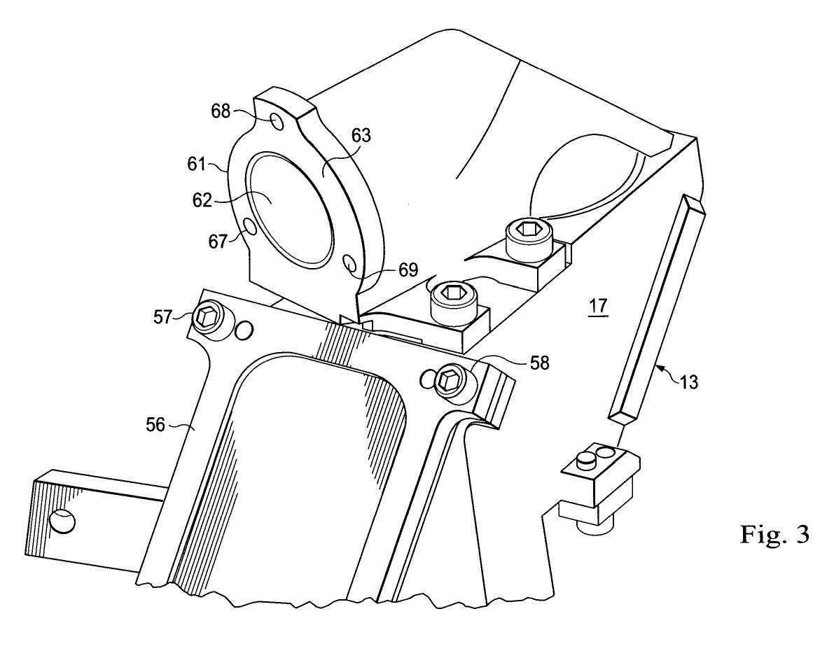

FIG. 3 is a diagrammatic fragmentary perspective view of a portion of the projection engine module 13. A support 56 of approximately rectangular shape is movably supported on the housing 17 of the projection engine module 13. Two adjusting screws 57 and 58 cooperatively engage the support 56 and the housing 17, so that rotation of the screws moves the associated end of the support 56 toward or away from the housing 17 in a manner that involves approximately pivotal movement of the support 56 about an end remote from the screws.

The housing 17 of the projection engine module 13 has an approximately circular flange 61. The flange 61 has an axially-facing planar side surface 63 on an outer side thereof. A cylindrical opening 62 extends through the center of the flange 61. Due to the opening 62, the flange 61 may sometimes be referred to herein as an annular flange. The flange 61 has three threaded openings 67, 68 and 69 that extend therethrough at respective locations which are spaced angularly about the opening 62. The opening 62 serves as an inlet port through which radiation can enter the projection engine module 13.

The polychromatic light source module 12 is a device that is described in detail in U.S. application Ser. No. 12/823,725 filed Jun. 25, 2010, and U.S. Application No. 61/220,378 filed Jun. 25, 2009, the entire disclosures of which are hereby incorporated herein by reference. The light source module 12 is discussed here only briefly, to an extent that will facilitate an understanding of certain aspects of the present invention.

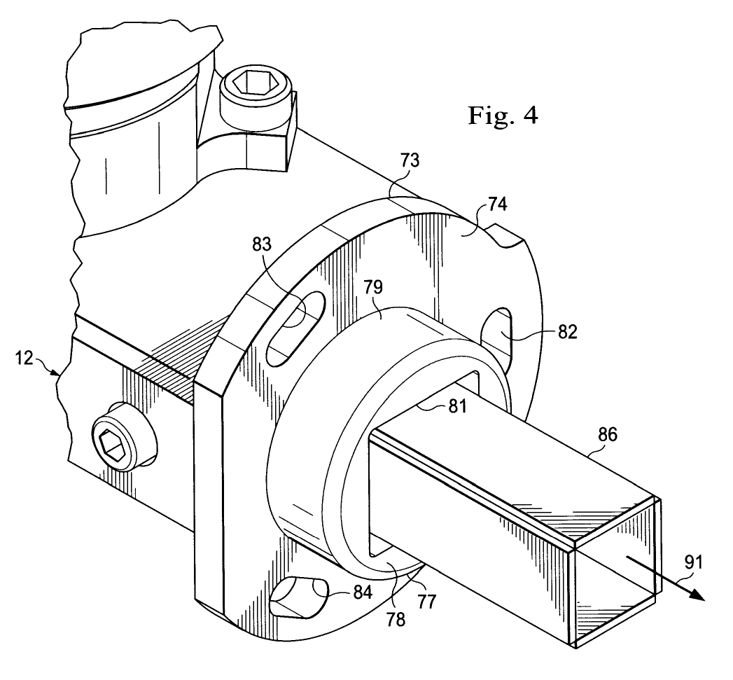

FIG. 4 is a diagrammatic fragmentary perspective view of an end portion of the polychromatic light source module 12 of FIG. 1. With reference to FIGS. 1 and 4, the module 12 has at one end an approximately circular flange 73 with an axially-facing planar side surface 74 on an outer side thereof. A cylindrical projection 77 extends axially outwardly from a central portion of the flange 73, and has an axially-facing planar end surface 78 at the outer end thereof. A radially-outwardly facing cylindrical surface 79 extends circumferentially around the projection 77, and has a diameter only slightly smaller than the diameter of the cylindrical opening 62 (FIG. 3). A rectangular opening 81 extends axially through the centers of the projection 77 and the flange 73. Three arcuate slots 82, 83 and 84 each open through the flange 73 at respective locations spaced angularly about the projection 77, and each extend approximately circumferentially with respect to the projection 77. A rectangular tube 86 has an end portion that extends outwardly through the opening 81 and projects beyond the outer end of the cylindrical projection 77. The rectangular tube 86 is part of a light pipe that is disposed within the light source module 12.

The light source module 12 includes three light emitting diode (LED) modules 87, 88 and 89, which respectively emit red, green and blue light into the light pipe at respective locations within the module 12. The radiation from these modules then travels through the light pipe and exits the light source module 12 through the tube 86, as indicated diagrammatically at 91 in FIG. 4. The LED modules 87-89 are selectively and independently controlled by a not-illustrated control circuit. At any given point in time, one, two or all three of the LED modules 87-89 may be energized and emitting radiation. When two or more of the LED modules are simultaneously emitting radiation, that radiation is mixed within the light pipe. Consequently, by appropriately controlling the LED modules 87-89, the radiation exiting the light pipe at 91 can have virtually any desired color within the visible spectrum.

With reference to FIGS. 3 and 4, the cylindrical projection 77 on the light source module 12 is inserted into the cylindrical opening 62 in the housing 17 of the projection engine module 13. The cylindrical surface 79 slidably engages the cylindrical inner surface of the opening 62, and the axially-facing annular surface 74 on the module 12 slidably engages the axially-facing annular surface 63 on the module 13. The three slots 82-84 are respectively aligned with the three threaded openings 67-69, and three screws each extend through a respective one of the slots 82-84 and engage a respective one of the threaded openings 67-69, one of these screws being visible at 92 in FIG. 1. By loosening these three screws slightly, the module 12 can be pivoted or “clocked” slightly relative to the housing 17 of the module 13, within limits imposed by engagement of the screws with the ends of the slots 82-84. This allows the orientation of the rectangular beam of light exiting the rectangular light tube 86 (FIG. 4) to be pivotally adjusted about the path of travel 91 relative to the inlet port defined by the opening 62 in the housing 17 of module 13. The three screws can then be tightened to fixedly secure the light source module 12 in an appropriate pivotal position with respect to the projection engine module 13.

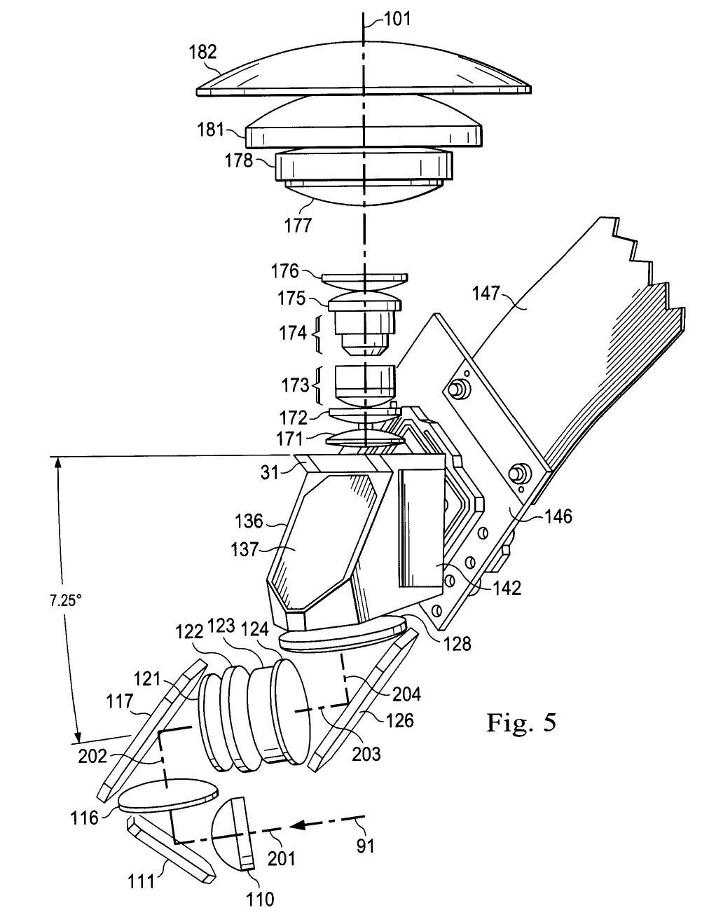

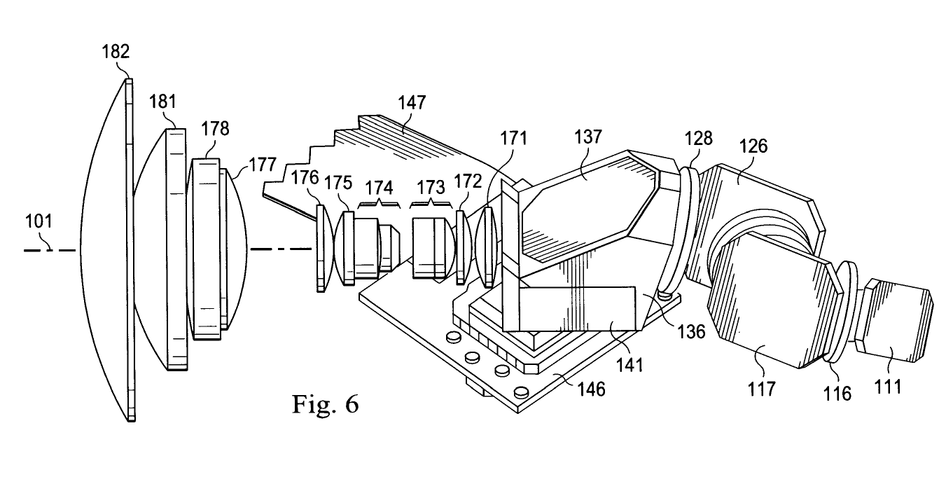

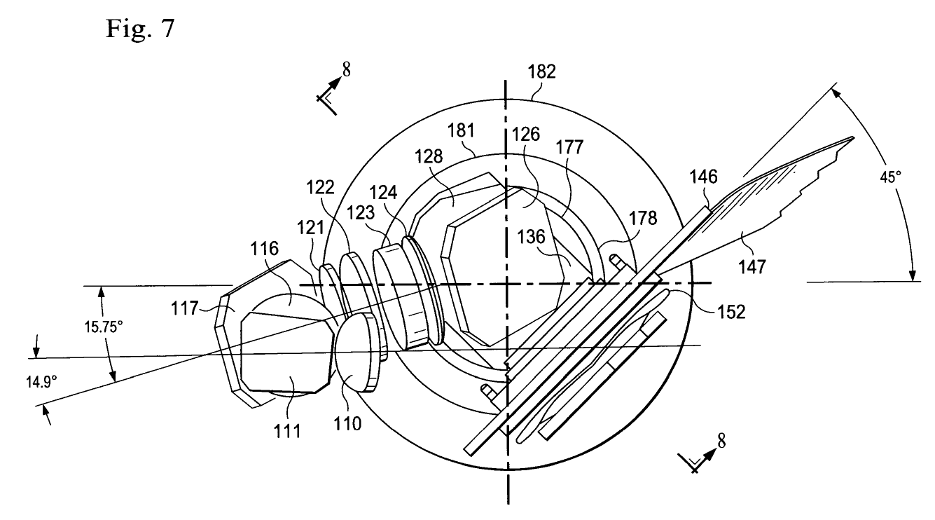

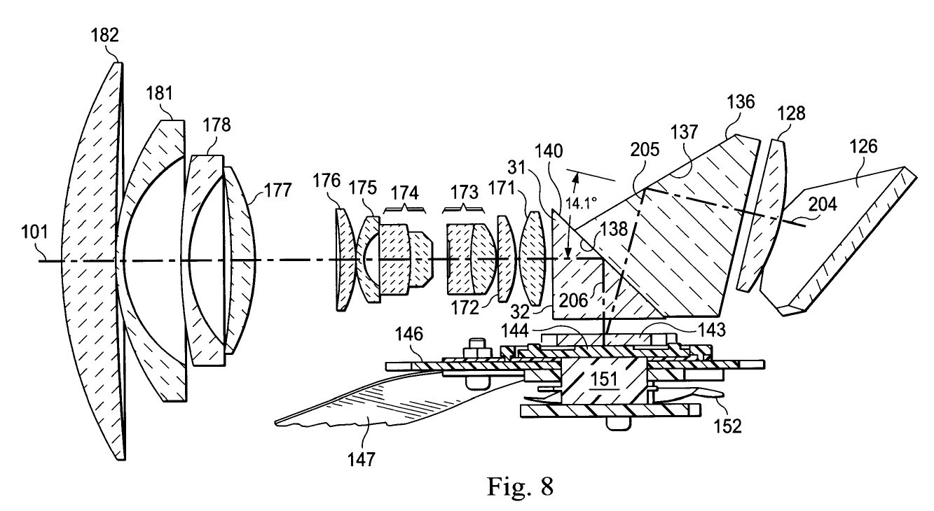

As shown in FIG. 1, the housing 17 of the projection engine module 13 includes two mounting plates 96 and 97 that can be used to removably mount the entire projection apparatus 10 within a larger system. With reference to FIG. 1, light from the light source module 12 enters the inlet port of the projection engine module 13 through opening 62 (FIG. 3), is converted into images as it travels through the module 13, then exits at 33 (FIG. 2) through the outlet port of the module 13 while entering the projection lens module 14, and eventually exits the module 14 along a path of travel 101. The modules 13 and 14 each include several optical components. FIG. 5 is a diagrammatic top view of the optical components provided within the projection engine module 13 and projection lens module 14. FIG. 6 is a diagrammatic side view of the optical components of FIG. 5. FIG. 7 is a diagrammatic rear view of the optical components of FIG. 5. FIG. 8 is a diagrammatic sectional view taken along section line 8-8 in FIG. 7.

Within the projection engine module 13, radiation 91 that enters the inlet port 62 passes through a stationary collimating lens 110, and is reflected by a stationary fold mirror 111. This radiation then passes through a stationary relay lens 116, is reflected by a stationary fold mirror 117, and then passes through an optional stationary filter 121, and three stationary relay lenses 122, 123 and 124. In the disclosed embodiment, when the optional filter 121 is present, it is an interference filter that reduces the color range of the radiation passing through it, in a manner so that images ultimately exiting the apparatus 10 at 101 (FIG. 1) have a generally monochrome appearance that simulates low-light nighttime conditions. However, it would alternatively be possible to provide a different type of filter at 121 that influences radiation passing through it in some other manner.

After passing through the filter 121 and the relay lenses 122-124, radiation is reflected by a fold mirror 126 that is fixedly supported on the inner side of the support 56 (FIG. 3). By turning the screws 57 and 58 (FIG. 3), the support 56 and thus the fold mirror 126 can be adjusted through a small range of pivotal movement. This permits a slight adjustment in the path of travel followed by radiation after it is reflected by the mirror 126. After being reflected by the fold mirror 126, the radiation passes through a field lens 128.

As best seen in FIG. 8, after radiation has passed through the field lens 128, it enters a stationary prism 136. The prism 136 is a total internal reflection (TIR) prism having a planar surface 137 that reflects substantially all radiation impinging on it. In the disclosed embodiment, this reflection is achieved through the principle commonly known as total internal reflection, which is a function of the angle at which radiation impinges on the surface 137, and a function of the differences in indexes of refraction of the materials (air and glass) disposed on opposite sides of the surface 137. The previously-mentioned prism 31 is also a TIR prism. The prism 31 has a planar surface 140 thereon, and the prism 136 has a planar surface 138 thereon. The planar surfaces 136 and 140 are parallel and spaced slightly from each other, with an air gap therebetween.

With reference to FIGS. 5 and 6, two plano-plano glass side plates 141 and 142 are adhesively secured to the sides of each of the prisms 136 and 31, in order to fixedly hold the two prisms in place with respect to each other, and thus maintain the air gap between the surfaces 138 and 140. In the disclosed embodiment, the side plates 141 and 142 are adhesively secured to the prisms 31 and 136 with a commercially-available epoxy adhesive of a type well known in the art, but could alternatively be secured to the prisms in any other suitable manner. Radiation reflected by the surface 137 of prism 136 travels through that prism to the surface 138. This radiation exits the prism 136 through the surface 138, enters the prism 31 through the surface 140, travels through the prism 31 to a bottom surface, and then exits the prism at 33 through the surface 32.

The radiation then reaches an imaging section of the projection engine module 13. The imaging section includes a protective window 143 that is transparent to visible light, and the radiation passes through the window 143. The imaging section also includes a digital imaging device 144 of a type that is known in the art, and therefore not described here in detail. The imaging device 144 has a plurality of micromirrors arranged in a rectangular array on an upper side thereof. After passing through the window 143, radiation impinges on the array of micromirrors. The above-mentioned clocking of the light source module 12 ensures the rectangular beam of light that exits the light pipe 86 at 91 and later arrives at device 144 is accurately aligned with respect to the rectangular array of micromirrors.

The imaging device 144 is supported on a circuit board 146, and a not-illustrated control circuit transmits electrical control signals through a ribbon cable 147 to the circuit board 146. These electrical control signals selectively effect independent pivotal movement of each of the micromirrors through a limited angle bounded by actuated and deactuated positions in which the micromirror reflects radiation in respective different directions. In particular, when a micromirror is actuated, reflected radiation travels to and enters the projection lens module 14. In contrast, when a micromirror is deactuated, reflected radiation does not travel to and enter the projection lens module 14.

A heat sink 151 engages a back side of the imaging device 144, in order to accept and dissipate heat. A leaf spring 152 urges the heat sink 151 upwardly in FIG. 8, in order to maintain the heat sink in firm contact with the device 144. The array of micromirrors in the device 144 take radiation arriving from the light source module 12, and convert it in a known manner into a series of successive images that are directed by actuated micromirrors to travel back into the prism 31. In the prism 31, substantially all of the energy of these images is reflected at the surface 140, due to the principle of total internal reflection. This energy then travels to and exits the prism 31 through the surface 32. As discussed above, the surface 32 of the prism 31 is considered to be the output port of the projection engine module 13.

Images that exit the projection engine module 13 and enter the projection lens module 14 successively pass through an adjustable focusing lens 171, a stationary illumination lens 172, a stationary illumination lens doublet 173, another stationary illumination lens doublet 174, stationary illumination lenses 175, 176, 177 and 178, and two adjustable field curvature lenses 181 and 182. During manufacture of the projection lens module 14, the assembled module 14 is placed in a not-illustrated calibration device at the factory, and then the position of the focusing lens 171 is axially adjusted until the center of a projected image is in focus. Next, the positions of the field curvature lenses 181 and 182 are axially adjusted until the outer portions of that image are also in focus. When the central portion and the outer portions of the image are all in focus, the setscrew 52 (FIG. 1) is tightened, and secures the focusing lens 171 in its correct position. In addition, the focusing lens 171 and the two field curvature lenses 181 and 182 are each adhesively bonded in position. In the disclosed embodiment, the adhesive is a commercially-available epoxy adhesive, but the lenses 171, 181 and 182 could alternatively be secured in position using any other suitable adhesive, or in other suitable manner.

With reference to FIGS. 5 and 8, a path of travel extends within the projection engine module 13 from the inlet port 62 to the imaging device 144. This path of travel has five successive segments that are each approximately linear, and each segment is approximately perpendicular to each segment adjacent to it. More specifically, an approximately linear segment 201 (FIG. 5) extends from the inlet port through the collimating lens 110 to the fold mirror 111, another approximately linear segment 202 that is approximately perpendicular to segment 201 extends from the fold mirror 111 through relay lens 116 to the fold mirror 117, another approximately linear segment 203 (FIG. 5) that is approximately perpendicular to segment 202 extends from the fold mirror 117 through the filter 121 and relay lenses 122-124 to the fold mirror 126, another approximately linear segment 204 (FIGS. 5 and 8) that is approximately perpendicular to segment 203 extends from the fold mirror 126 through the field lens 128 to the reflective surface 137 of prism 136, and another approximately linear segment 205 (FIG. 8) that is that is approximately perpendicular to segment 204 extends from the surface 137 through the two prisms 136 and 31 to the micromirror array in the digital imaging device 144.

Images produced by the imaging device 144 then follow another path of travel from the device 144 through the remaining optics, and this path of travel includes two approximately linear segments. More specifically, an approximately linear segment extends from the device 144 to the surface 140 of prism 31, and another approximately linear segment 101 that is approximately perpendicular to segment 206 extends from the prism surface 140 through the lenses 171-178 and 181-182.

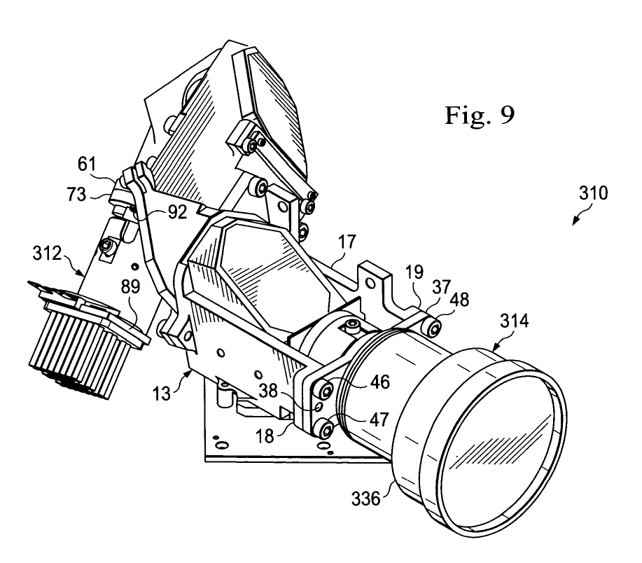

FIG. 9 is a diagrammatic perspective view of a projection apparatus 310 that is an alternative embodiment of the projection apparatus 10 of FIG. 1. The projection apparatus 310 of FIG. 9 includes the projection light engine module 13 of FIG. 1, without any change. The projection apparatus 310 of FIG. 9 also includes a monochromatic light source module 312 and a projection lens module 314 that are each detachably coupled to the projection light engine module 13.

The light source module 312 is similar to the light source module 12 of FIG. 1, except that the module 312 has only a single LED module 89, which emits green light. Alternatively, it could be an LED module that produces light of some other color. The monochromatic light source module 312 is identical to a device that is disclosed in detail in above-mentioned U.S. application Ser. Nos. 12/823,725 and 61/220,378. The monochromatic light source module 312 is therefore discussed here only briefly, to an extent that will facilitate an understanding of certain aspects of the present invention.

The light source module 312 has structure at one end that is similar to the structure shown in FIG. 4 and described above. This structure is used to detachably secure the monochromatic light source module 312 to the flange 61 on the housing 17 of the projection engine module 13, in the same manner described above for the light source module 12. The light source modules 12 and 312 are easily interchangeable, and either can be detachably secured to or detached from the flange 61 at the inlet port of the housing 17.

The projection lens module 314 shown in FIG. 9 has a flange 37 that is identical to the flange 37 of the module 14 in FIG. 1, and thus can easily be detachably secured to or detached from the housing 17 of the projection engine module 13, in the same manner described above for the lens module 14. Thus, the projection lens modules 14 and 314 are easily interchangeable. The lens modules 14 and 314 are designed to project light onto not-illustrated screens that have different sizes and that are spaced by different distances from the respective lens modules. The lens module 314 of FIG. 9 differs from the lens module 14 of FIG. 1 only in that (1) the arrangement of lenses within module 314 is different from the arrangement of lenses within module 14, and (2) the housings 336 and 36 of the modules 14 and 314 have slightly different shapes, in order to accommodate the different arrangements of lenses therein.

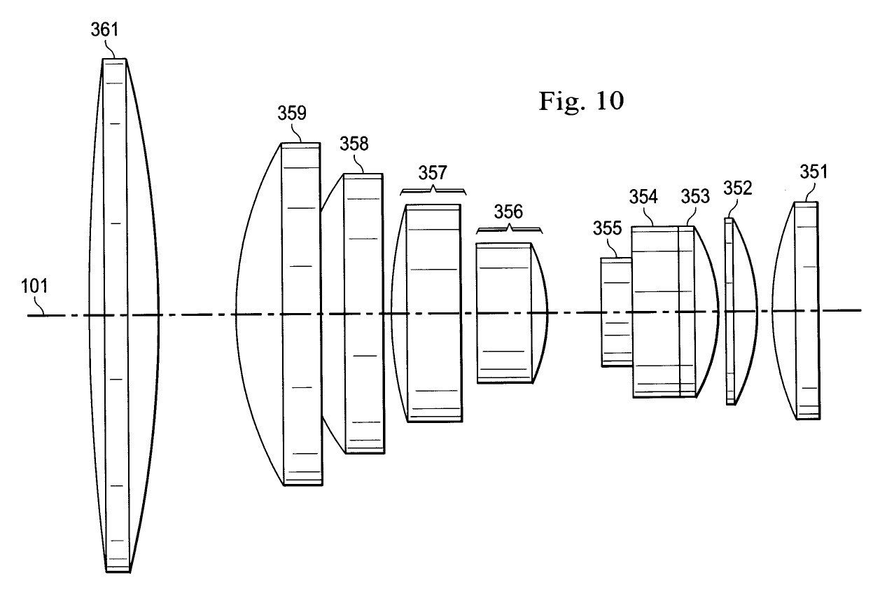

FIG. 10 is a diagrammatic view showing the lenses that are provided within the projection lens module 314 of FIG. 9. From right to left, images pass successively through an adjustable focusing lens 351, stationary illuminating lenses 352-355, stationary illuminating lens doublets 356 and 357, stationary illuminating lenses 358 and 359, and an adjustable field curvature lens 361. During fabrication of the lens module 314, the adjustable lenses 351 and 361 are successively positioned, and then are adhesively secured in position, in a manner similar to that described above for the adjustable lenses in the projection lens module 14.

As discussed earlier, the path of travel followed by radiation and images through the projection engine module 13 has multiple folds that are arranged so the entire apparatus 10 of FIG. 1 and the entire apparatus 310 of FIG. 9 are each very compact, but without any degradation to their illumination performance. Moreover, the core projection engine module 13 can be used in a variety of different applications without any modification, simply by detachably coupling to it an appropriate light source module 12 or 312 (or some other suitable light source module), and an appropriate projection lens module 14 or 314 (or some other suitable lens module).

Although selected embodiments have been illustrated and described in detail, it should be understood that a variety of substitutions and alterations are possible without departing from the spirit and scope of the present invention, as defined by the claims that follow.

What is claimed is:

1. An apparatus comprising a projection module that includes:
an input port having light source module mounting structure;
an output port having lens module mounting structure;
an image forming section that generates images from incident radiation; and
optics that route radiation arriving through said input port along a first path of travel to said image forming section, and that route images from said image forming section along a second path of travel to and through said output port.

2. An apparatus according to claim 1, wherein said optics are configured so that said first path of travel has a plurality of folds.

3. An apparatus according to claim 2, wherein said first path of travel has a plurality of successive segments that are each approximately linear, each said segment other than the first thereof extending at an angle greater than 45° with respect to the immediately preceding segment.

4. An apparatus according to claim 2,
wherein said first path of travel includes successive first, second, third, fourth, and fifth segments that are each approximately linear, said first segment commencing at said input port and said fifth segment ending at said image forming section; and
wherein said optics include first, second, third, and fourth lenses, said first, second, third and fourth segments respectively extending through said first, second, third and fourth lenses.

5. An apparatus according to claim 4, including a filter section, said third segment extending though said filter section.

6. An apparatus according to claim 4, wherein said optics include fifth and sixth lenses, said third segment extending through said fifth and sixth lenses.

7. An apparatus according to claim 4, wherein said optics include:
a first reflective element disposed at an intersection of said first and second segments;
a second reflective element disposed at an intersection of said second and third segments; and
a third reflective element disposed at an intersection of said third and fourth segments.

8. An apparatus according to claim 7,
wherein said first and second reflective elements are stationary; and
wherein a position of said third reflective element is adjustable.

9. An apparatus according to claim 7, wherein said optics include a prism having a reflective surface disposed at an intersection of said fourth and fifth segments.

10. An apparatus according to claim 1, wherein said second path of travel includes successive first and second segments that are each approximately linear and that extend at an angle with respect to each other, said first segment commencing at said image forming section, and said second segment ending at said output port.

11. An apparatus according to claim 10, wherein said optics include a prism having a reflective surface disposed at an intersection of said first and second segments.

12. An apparatus according to claim 1, including a filter section, one of said first and second paths of travel extending through said filter section.

13. An apparatus according to claim 1, wherein said image forming section includes an array of movable micromirrors, said first path of travel ending at said array and said second path of travel commencing at said array.

14. An apparatus according to claim 1, including a light source module that is detachably coupled to said light source module mounting structure, and that supplies radiation through said input port.

15. An apparatus according to claim 1, including a lens module that is detachably coupled to said lens module mounting structure, said lens module including a lens that influences the images from said output port.

16. An apparatus according to claim 1, including a lens module that is detachably coupled to said lens module mounting structure, said lens module including a plurality of lenses that each influence the images from said output port.

17. A method of operating a projection module having an input port with light source module mounting structure, an output port with lens module mounting structure, an image forming section, and optics, said method comprising:
routing radiation arriving through said input port along a first path of travel defined by said optics to said image forming section;
generating images at said image forming section from said radiation arriving along said first path of travel; and
routing images from said image forming section to and through said output port along a second path of travel defined by said optics.

18. A method according to claim 17, including configuring said optics so that said first path of travel has a plurality of folds.

19. A method according to claim 17,
wherein said optics include a reflective element disposed along said first path of travel;
wherein said routing radiation along said first path of travel includes reflecting said radiation with said reflective element; and
including adjusting a position of said reflective element to move a terminal portion of said first path of travel relative to said image forming section.

20. A method according to claim 17, wherein said routing said radiation includes causing said radiation to pass through a filter section.

21. A method according to claim 17, including:
detachably coupling a light source module to said light source module mounting structure; and
supplying radiation from said light source module to and through said input port.

22. A method according to claim 17, including:
detachably coupling a lens module to said lens module mounting structure; and
influencing the images from said output port with a lens in said lens module.
